(19) United States
(12) Patent Application Publication
(10) Pub. No.: US 2026/0278385 A1
(43) Pub. Date: Sep. 17, 2026

(54) TRAINING MULTIMODAL MACHINE LEARNING MODELS USING CROSS-MODALITY CONTRASTIVE LEARNING

(71) Applicant: QUALCOMM Incorporated, San Diego, CA (US)

(72) Inventors: Ang LI, San Diego, CA (US); Arash BEHRAVESH, San Diego, CA (US); Christos LOUIZOS, Amsterdam (NL); Joseph Binamira SORIAGA, San Diego, CA (US)

(21) Appl. No.: 19/474,109

(22) PCT Filed: Dec. 12, 2023
(86) PCT No.: PCT/US2023/083617

§ 371 Date: Oct. 9, 2025

(30) Foreign Application Priority Data
May 17, 2023 (GR) 20230100403

(51) Int. Cl. G06N 3/088; G06N 3/045

(52) U.S. Cl. CPC G06N 3/088; G06N 3/045

(57) ABSTRACT

Techniques and apparatuses for training a machine learning model using federated learning and multimodal data at a plurality of client devices. An example method generally includes receiving, at a local device from a server, information defining a global machine learning model. Generally, the global machine learning model includes a plurality of modality-specific encoders, and each respective encoder of the plurality of modality-specific encoders is generally trained to encode data from a respective data modality into a latent space representation. The one or more modality-specific encoders of the global machine learning model are refined based on contrastive learning with modality-specific data at the local device.

### CROSS-REFERENCE TO RELATED APPLICATIONS

This application claims priority to and benefit of Greece Patent Application Serial No. 20230100403, entitled “Training Multimodal Machine Learning Models Using Cross-Modality Contrastive Learning,” filed May 17, 2023, and assigned to the assignee hereof, the entire contents of which are hereby incorporated by reference.

### INTRODUCTION

Aspects of the present disclosure relate to machine learning.

Federated learning generally allows for client devices participating in a federated learning scheme to train a global machine learning model without sharing the local data sets used by these client devices. By doing so, federated learning can be used to train a machine learning model to generate inferences based on sensitive data or data which should remain private, such as biometric data, sensor data, images captured during operation of a self-driving vehicle (which may expose the driving patterns of a user), financial data, or the like. Generally, each client device participating in the federated learning scheme can use local data to train a local version of the machine learning model, and local versions of the machine learning model generated by each client device may be combined into a global machine learning model that can be deployed for use by various devices. Because each client device may generally have different local data (e.g., from different operating environments), federated learning may allow for a machine learning model to be trained to generate inferences across a wide variety of environments in which client devices operate.

The data used to train a machine learning model may be in various modalities. For example, a machine learning model may be trained based on textual data, image data, video data, audio data, time-series data, sensor data, and/or data from various other modalities. For machine learning models trained using multimodal data, it may be assumed that each client device participating in the federated learning scheme has data from the same set of modalities. However, client devices may capture data from different modalities; thus, each client device may have incomplete data based on which inferences can be performed relative to the multimodal data used to train the machine learning model.

### BRIEF SUMMARY

Certain aspects provide a method for training a machine learning model. The method generally includes receiving, at a local device from a server, information defining a global machine learning model. Generally, the global machine learning model includes a plurality of modality-specific encoders, and each respective encoder of the plurality of modality-specific encoders is generally trained to encode data from a respective data modality into a latent space representation. The one or more modality-specific encoders of the global machine learning model are refined based on contrastive learning with modality-specific data at the local device.

Other aspects provide a method for distributing training of a machine learning model across client devices. The method generally includes training, based on labeled training data from a plurality of modalities, a global machine learning model. Generally, the global machine learning model includes a plurality of modality-specific encoders, and each respective encoder of the plurality of modality-specific encoders is generally trained to encode data from a respective data modality into a latent space representation. The global machine learning model is deployed to one or more client devices.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of various aspects of the present disclosure and are therefore not to be considered limiting of the scope of this disclosure.

FIG. 1 depicts an example environment in which machine learning models are trained by a plurality of client devices using federated learning techniques and multimodal data, according to aspects of the present disclosure.

FIG. 2 illustrates an example of training a machine learning model using federated learning techniques and multimodal data, according to aspects of the present disclosure.

FIG. 3 illustrates an example of self-contrastive learning used by a client device participating in a federated learning scheme to refine a machine learning model, according to aspects of the present disclosure.

FIG. 4 illustrates example operations that may be performed by a client device for training a machine learning model based on multimodal data, according to aspects of the present disclosure.

FIG. 5 illustrates example operations that may be performed by a server to distribute a multimodal machine learning model to a plurality of client devices, according to aspects of the present disclosure.

FIG. 6 illustrates an example implementation of a processing system in which a machine learning model can be trained, according to aspects of the present disclosure.

FIG. 7 illustrates an example implementation of a processing system in which training of a machine learning model across client devices can be performed, according to aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for training a machine learning model using federated learning and multimodal data at a plurality of client devices. As used herein, multimodal data generally refers to different types of data which may be used in a machine learning model, such as data associated with or generated by different types or classes of input devices.

In systems where a machine learning model is trained using federated learning, the machine learning model is generally defined based on model updates (e.g., changes in weights or other model parameters) generated by each of a plurality of participating client devices. Generally, each of these client devices may train a model using data stored locally on the client device. By doing so, the machine learning model may be trained using a wide variety of data, which may reduce the likelihood of the resulting global machine learning model underfitting data (e.g., resulting in a model that neither fits the training data nor generalizes to new data) or overfitting the data (e.g., resulting in a model that fits too closely to the training data such that new data is inaccurately generalized).

In some cases, a machine learning model may be trained to generate inferences based on data from different modalities. For example, in an automated driving scenario in which advanced driver-assistance systems (ADASs) use machine learning models to control a motor vehicle, a machine learning model may be trained to generate inferences based on image data and sensor data (e.g., distance sensor data, such as that from radar, ultrasonic sensors, light detection and ranging (LIDAR) systems, etc.), as well as data from other modalities that may be appropriate for such a scenario. However, the devices on which the machine learning model may be deployed may not capture the same modalities of data as that used to train the machine learning model. For example, while a global machine learning model used in these ADASs may be trained based on image data and sensor data, some local devices on which the global machine learning model may be deployed may capture image data but may not capture certain sensor data, for example, due to the absence of such sensors.

Aspects of the present disclosure provide techniques for federated learning of machine learning models that allows client devices to leverage multiple data modalities in inferencing when client devices capture data from a subset of these multiple data modalities. As discussed in further detail herein, federated learning techniques may allow for participating client devices to refine modality-specific portions of the global machine learning model so that the global machine learning model is adapted to the capabilities of the client device. However, because the global machine learning model may be trained based on multimodal data, learned correlations between data from different modalities may be leveraged during inferencing. Thus, a client device can leverage these learned correlations between data from different modalities to generate inferences based on local data which may not include some of the data modalities used to train the global machine learning model, thus improving inference accuracy.

### Example Federated Learning Architecture for Training Multimodal Machine Learning Models Using Cross-Modality Contrastive Learning

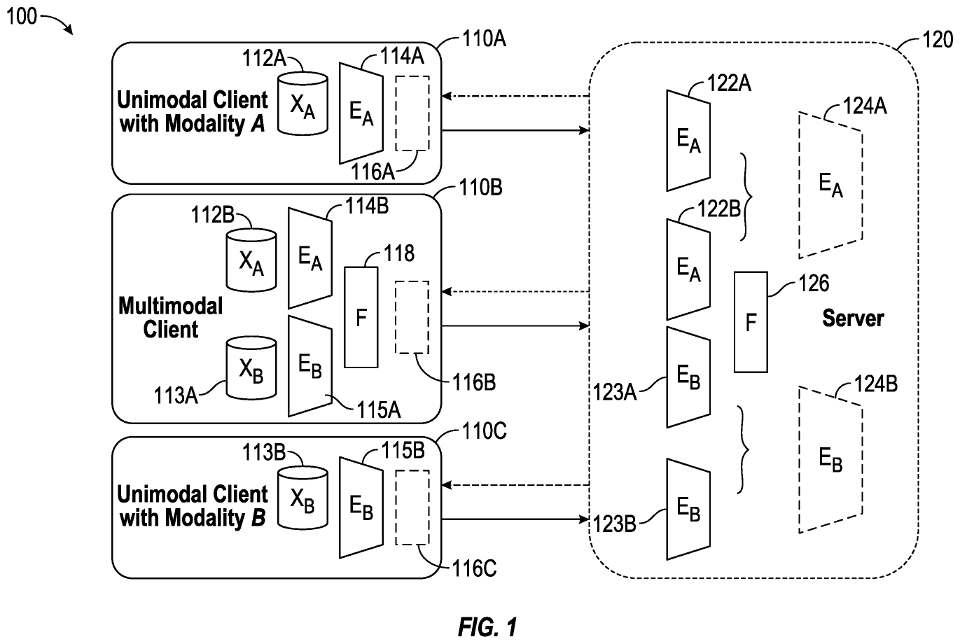

FIG. 1 depicts an example environment 100 in which machine learning models are trained by a plurality of client devices using federated learning techniques and multimodal data, according to aspects of the present disclosure.

As illustrated, the environment 100 includes a plurality of client devices 110A-110C (hereinafter, collectively referred to as “client device(s) 110”) and a server 120. The client devices 110 may be representative of various devices on which a machine learning model can be deployed for execution, such as a smartphone, a tablet computer, an autonomous vehicle, or the like.

As illustrated, each client device 110 can obtain data in one or more modalities (e.g., via one or more input devices, such as cameras, sensors, textual input, sound recording devices, etc.) and use modality-specific portions of a global machine learning model to generate various inferences based on the obtained data. For example, the client device 110A can obtain data x_{A} 112A in a first modality, the client device 110C can obtain data x_{B} 113B in a second modality, and the client device 110B can obtain data x_{A} 112B in the first modality and x_{B} 113A in the second modality.

The client device 110A may generate an inference based on the input data x_{A} 112A. For instance, an encoder 114A can encode the input data x_{A} 112A into a latent space representation. Then a classifier 116A can generate an inference (e.g., classify the input data xₐ 112A) and output the generated inference for use in performing one or more actions on the client device 110A. Similarly, at the client device 110C, to generate an inference based on the input data x_{B} 113B, an encoder 115B can encode the input data x_{B} 113B into a latent space representation, and a classifier 116C can generate an inference (e.g., classify the input data x_{B} 113B) and output the generated inference for use in performing one or more actions on the client device 110C.

The client device 110B, however, may be a multimodal client that, as illustrated, can obtain data (x_{A} 112B and x_{B} 113A) in both the first modality and the second modality. To generate inferences based on data x_{A} 112B in the first modality and data x_{B} 113A in the second modality, encoders 114B and 115A can be used to encode the data x_{A} 112B and the data x_{B} 113A, respectively, into latent space representations. The latent space representations of the data x_{A} 112B and the data x_{B} 113A may be fused via fusion block 118. The fused latent space representations of the data x_{A} 112B and the data x_{B} 113A may be input into a classifier 116B. The inference generated by classifier 116B may be used by the client device 110B to perform one or more actions on the client device 110B.

While the foregoing describes the classification of data using machine learning models deployed on the client devices 110, it should be recognized that inferences can be generated using functional blocks other than the classifiers 116 (e.g., 116A-C) illustrated in FIG. 1. For example, embeddings or other encodings of an input generated by the encoders 114 (e.g., 114A-114B) and/or 115 (e.g., 115A-115B) can be projected into a latent space representation via a projection block. Various techniques (e.g., clustering, k-nearest neighbor, etc.) can be used to generate an inference with respect to an input processed by the machine learning models deployed on the client devices 110.

The server 120 generally trains a global machine learning model that includes encoders for each of the plurality of data modalities that are present on the client devices 110 and deploys the global machine learning model to the client devices 110 for both inference and refinement based on local data at the client devices 110. As illustrated, the global machine learning model trained at the server 120 includes a plurality of client-trained encoders (e.g., 122A, 122B) (which may be collectively referred to encoder(s) 122) for data in the first modality, a plurality of client-trained encoders 123A, 123B (which may be collectively referred to as encoder(s) 123) for data in the second modality, a plurality of aggregated encoders 124A, 124B (which may be collectively referred to as aggregated encoder(s) 124), and a fusion block 126 that fuses representations of data from different modalities into a common latent space so that data from one modality can be augmented with data from other modalities that may or may not be present at any given client device 110 in the environment 100.

In some aspects, the global machine learning model may be initially trained based on a multimodal training data set

$$𝒟 = {\{ ( {x}_{1}^{i} , … , {x}_{M}^{i} , {y}^{i} ) \}}_{i = 1}^{\vert 𝒟 \vert} ,$$

where M represents a number of different modalities of data included in the multimodal training data set [symbol] over which the global machine learning model is trained,

$${x}_{m ∈ M}^{i}$$

represents the i^{th} sample of data in the m^{th} modality, and yⁱ represents a label associated with the samples

$${x}_{1}^{i}$$

through

$${x}_{M}^{i}$$

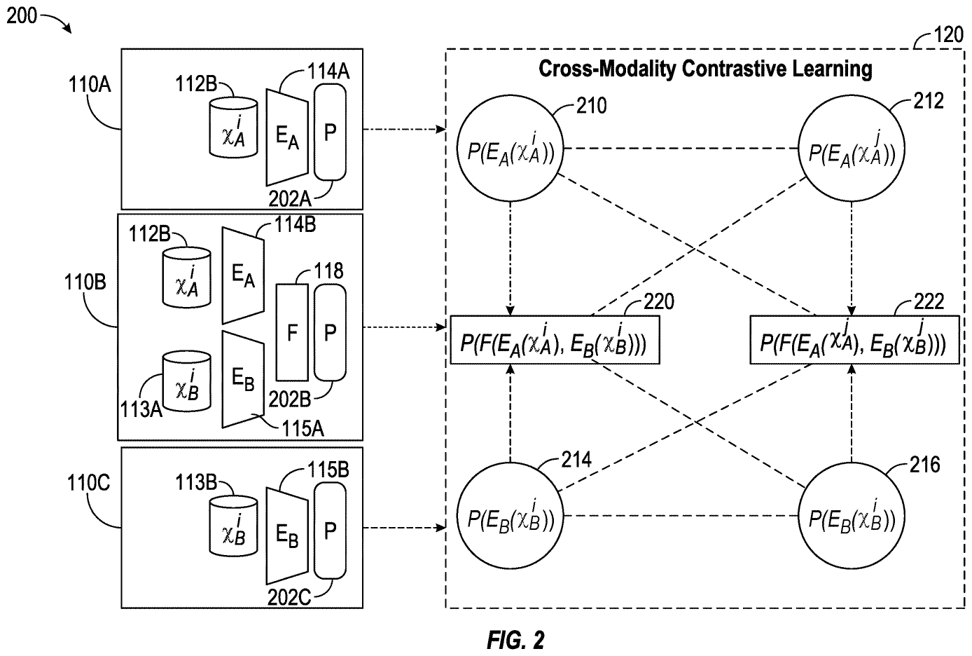

in the training data set [symbol] . In some aspects, the server 120 can train the global machine learning model using cross-modality contrastive learning, described in further detail below with respect to FIG. 2, in order to independently learn an encoder 122, 123 (that may be amongst others that are not illustrated in FIG. 1) for each modality of data for which the global machine learning model is trained to process. Generally, the encoders 122, 123 may allow for the generation of features for a single modality of data such that features may be similarly generated for unimodal data and multimodal data.

To refine the global machine learning model, the server 120 deploys the global machine learning model to the client devices 110. As discussed in further detail herein, each client device 110 updates modality-specific portions of the global machine learning model based on unlabeled training data local to the client device 110 and provides these updates to the server 120 for use in updating the global machine learning model. Generally, a client device may have local data

$${𝒟}_{k} = {\{ ( {x}_{1}^{i} , … , {x}_{n}^{i} ) \vert n ∈ M \}}_{i = 1}^{\vert {𝒟}_{k} \vert}$$

that can be used to refine the global machine learning model, where [symbol] represents the data available on the k^{th} client device 110 and

$$( {x}_{1}^{i} , … , {x}_{n}^{i} )$$

represents the n^{th} modality data for the i^{th} sample in [symbol] .

The updates generated by the client devices 110 may include, for example, updated weights, biases, embeddings, and other information defining various characteristics of the machine learning model after refinement based on the unlabeled training data local to the client devices 110. For example, as illustrated, the client device 110A can provide a client-trained encoder 122A to the server 120, the client device 110B can provide client-trained encoders 122B and 123A to the server 120, and the client device 110C can provide a client-trained encoder 123B to the server 120, for aggregation into an updated version of the global machine learning model. Subsequently, the server 120 can aggregate the client-trained encoders 122A and 122B into an aggregated encoder 124A for the first modality of data and can aggregate the client-trained encoders 123A and 123B into an aggregated encoder 124B for the second modality of data. While FIG. 1 illustrates that client device 110B can generate and perform inferences based on two modalities of data, it should be recognized that a device on which the global machine learning model is deployed may perform inferences on and refine modality-specific encoders based on any number of data modalities.

FIG. 2 illustrates an example 200 of training a machine learning model using federated learning techniques and multimodal data, according to aspects of the present disclosure. With reference to FIGS. 1 and 2, the training may be performed, for example, to generate an initial version of the global machine learning model based on labeled mixed modality data sets available at the server 120.

As illustrated, the machine learning model may be trained based on cross-modality contrastive learning so that modality-specific encoders can complement information from other modalities. To do so, assume that data in a first modality is projected by a projection block 202A in client device 110A into a representation

$$P ( {E}_{A} ( {x}_{A}^{i} ) ) 210 ,$$

where

$${E}_{A} ( {x}_{A}^{i} )$$

represents the encoding of input data

$${x}_{A}^{i}$$

generated by a first modality-specific encoder, and P represents a projection function. Meanwhile, assume that data in a second modality, having the same label (e.g., being complementary information to

$${x}_{A}^{i} ,$$

such as data captured collectively as sample i), is projected by a projection block 202C in client device 110C into a representation

$$P ( {E}_{B} ( {x}_{B}^{i} ) ) 214 ,$$

where

$${E}_{B} ( {x}_{B}^{i} )$$

represents the encoding of input data

$${x}_{B}^{i}$$

generated by a second modality-specific encoder. The projection of the fused encodings of

$${x}_{A}^{i} and {x}_{B}^{i}$$

generated by the projection block 202B in client device 110B may thus be represented as

$$P ( F ( {E}_{A} ( {x}_{A}^{i} ) , {E}_{B} ( {x}_{B}^{i} ) ) )$$

where F represents a fusion function that generates an embedding based on a fusion or other combination of the encodings of input data

$${x}_{A}^{i} and {x}_{B}^{i} .$$

Similarly, for sample j, data in the first modality is projected by the projection block 202A into a representation

$$P ( {E}_{A} ( {x}_{A}^{j} ) ) 212 ,$$

data in the second modality is projected by the projection block 202C into a representation

$$P ( {E}_{B} ( {x}_{B}^{j} ) ) 216 ,$$

and the fused encodings are projected by the projection block 202B into a representation

$$P ( F ( {E}_{A} ( {x}_{A}^{j} ) , {E}_{B} ( {x}_{B}^{j} ) ) ) 222.$$

To train the machine learning model to complement data from one modality to data from other modalities, a similarity metric s_{A,F} between representations 210 of data from the first modality A and representations 220 of data from a fused modality F may be represented by the equation:

$${s}_{A , F} ( i , j ) = exp ( \frac{sim ( {z}_{A}^{i} , {z}_{F}^{j} )}{τ} )$$

where

$${z}_{A}^{i} = P ( {E}_{A} ( {x}_{A}^{i} ) )$$

(e.g., corresponds to a projected embedding of the data in the first modality),

$${z}_{F}^{j} = P ( F ( {E}_{A} ( {x}_{A}^{j} ) , {E}_{B} ( {x}_{B}^{j} ) ) )$$

(e.g., corresponds to a projected fused embedding of the data in the first modality and data in other modalities), and τ represents a “temperature” scalar that controls growth of an exponential function.

The similarity metric Ω_{A} between negative pairs of data, or different samples of data with different labels at the server, may be represented by the equation:

$${Ω}_{A} ( i ) = {\sum }_{i \neq j} ( {s}_{A , F} ( i , j ) + {s}_{A , A} ( i , j ) + {s}_{F , F} ( i , j ) )$$

That is, the similarity metric Ω_{A} may be calculated based on (1) the similarity between projections

$$P ( {E}_{A} ( {x}_{A}^{i} ) ) 210 and P ( F ( {E}_{A} ( {x}_{A}^{j} ) , {E}_{B} ( {x}_{B}^{j} ) ) ) 222 ,$$

(2) the similarity between projections

$$P ( {E}_{A} ( {x}_{A}^{i} ) ) 210 and P ( {E}_{A} ( {x}_{A}^{j} ) ) 212 ,$$

and (3) the similarity between projections

$$P ( F ( {E}_{A} ( {x}_{A}^{i} ) , {E}_{B} ( {x}_{B}^{i} ) ) ) 220 and P ( F ( {E}_{A} ( {x}_{A}^{j} ) , {E}_{B} ( {x}_{B}^{j} ) ) ) 222.$$

A contrastive loss may be calculated between the projection of an input encoded using a modality-specific encoder and a fused projection of the input for the same sample i. This contrastive loss l_{A}(i) may be represented by the equation:

$${l}_{A} ( i ) = - log \frac{{s}_{A , F} ( i , i )}{{Ω}_{A} ( i )}$$

Generally, the contrastive loss lₐ(i) represents a loss function that is designed to reduce a distance between encodings of similar inputs and increase a distance between encodings of dissimilar inputs.

The final training loss [symbol] , based on which the global machine learning model may be trained, may be represented by the equation:

$$ℒ ( ℬ ) = {\sum }_{i = 1}^{B} {l}_{A} ( i ) + {\sum }_{i = 1}^{B} {l}_{B} ( i )$$

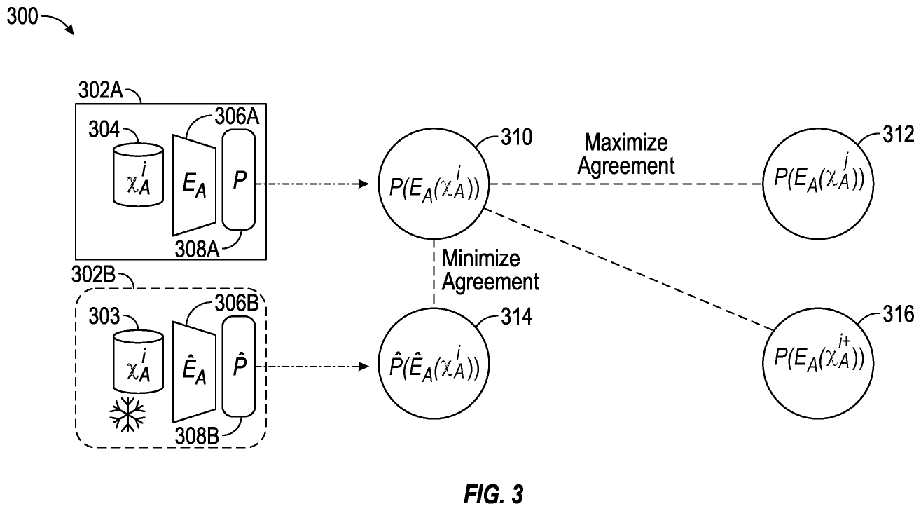

FIG. 3 illustrates an example 300 of self-contrastive learning used by a client device participating in a federated learning scheme (e.g., one of the client devices 110 illustrated in FIG. 1) to refine a machine learning model, according to aspects of the present disclosure.

Self-contrastive learning allows for a client device to refine a pre-trained modality-specific encoder to unlabeled local data while maintaining the ability of the global machine learning model (including the refined modality-specific encoder) to complement local data in one modality with data from other modalities. To do so, self-contrastive learning may leverage the ability of a modality-specific encoder to generate features for an input that, when projected into a latent space, are similar to the latent space representation of a fused feature generated based on data from different modalities. Thus, the fusion module may effectively serve as a helper function in performing self-contrastive learning on the client device.

Generally, in self-contrastive learning, representations may be generated for input data

$${x}_{A}^{i}$$

304 using a learnable block 302A and a frozen block 302B. The learnable block 302A may include a learnable encoder A 306A (e.g., an encoder being refined based on local data at the client device). The frozen block 302B may include a fixed encoder Â 306B (e.g., the encoder deployed as part of the global machine learning model). To refine the learnable encoder A 306A, a similarity metric S_{A,Â} may be calculated between representations extracted for the input data

$${x}_{A}^{i}$$

304 by the learnable encoder A 306A and the fixed encoder Â 306B (and, as illustrated, projected through the projection blocks 308A and 308B, respectively), according to the equation:

$${s}_{A , \hat{A}} ( i , j ) = exp ( \frac{sim ( {z}_{A}^{i} , {z}_{\hat{A}}^{j} )}{τ} )$$

where

$${z}_{A}^{i} = P ( {E}_{A} ( {x}_{A}^{i} ) ) , {z}_{\hat{A}}^{i} = P ( {E}_{\hat{A}} ( {x}_{A}^{i} ) ) ,$$

and τ represents a distance function.

The similarity metric Ω_{A} between pairs of inputs processed by the learnable encoder A 306A and fixed encoder Â 306B may be represented by the equation:

$${Ω}_{A} ( i ) = {\sum }_{i \neq j} ( {s}_{A , \hat{A}} ( i , j ) + {s}_{A , A} ( i , j ) )$$

Finally, to train the learnable encoder A 306A, a local training loss may be minimized, or at least reduced. This local training loss [symbol] may be represented by the equation:

$$ℒ ( ℬ ) = - {\sum }_{i = 1}^{B} log \frac{{s}_{A , \hat{A}} ( i , i )}{{Ω}_{A} ( i )}$$

In performing self-contrastive learning, thus, the client device can use the local training loss function to maximize, or at least increase, an agreement (e.g., minimize, or at least reduce, a difference) between projections 310, 312, and 316 generated based on the learnable encoder A 306A and minimize, or at least reduce, agreement between projection 314 generated for an input based on the fixed encoder Â 306B.

The resulting learned encoder A 306A may subsequently be used in inferencing operations on the client device and be provided to a server for aggregation with other learned encoders to update the global machine learning model. In performing self-contrastive learning at a client device based on modality-specific local data at the client device, the server can allow for encoders for different modalities of data to be updated by different groups of client devices. Updates to the global machine learning model, or at least to modality-specific portions of the global machine learning model, may be aggregated so that the global machine learning model can be updated on a modality-wise basis. By doing so, aspects of the present disclosure may allow for a global machine learning model to be trained to generate inferences based on data in varying modalities while leveraging knowledge derived from data in missing modalities, thus improving inference performance for a global machine learning model trained using federated learning techniques.

### Example Methods for Training Multimodal Machine Learning Models Using Cross-Modality Contrastive Learning

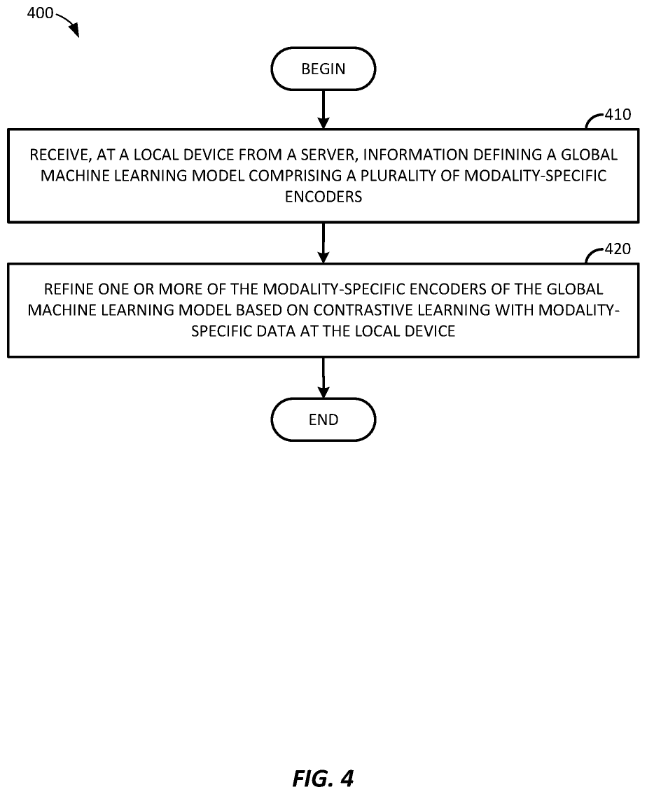

FIG. 4 illustrates example operations 400 that may be performed by a client device (e.g., one of the client devices 110 illustrated in FIG. 1, also referred to as a local device) for training a machine learning model based on multimodal data (e.g., as discussed with respect to the example 200 illustrated in FIG. 2 and/or the example 300 illustrated in FIG. 3), according to aspects of the present disclosure.

As illustrated, the operations 400 begin at block 410, with receiving, at a local device from a server (e.g., the server 120), information defining a global machine learning model. Generally, the global machine learning model includes a plurality of modality-specific encoders, and each respective encoder of the plurality of modality-specific encoders may be trained to encode data from a respective data modality into a latent space representation.

In some aspects, the global machine learning model may be a model trained to fuse latent space representations generated by the plurality of modality-specific encoders into a combined representation based on which an inference can be generated. The model may allow for inferencing based on a single modality-specific encoder (e.g., when inferencing is performed based on data in a single modality and without data from a second modality, such as inferencing based on visual data alone, inferencing based on sensor data alone, or the like) or a fusion of encoded outputs generated by a plurality of modality-specific encoders (e.g., when inferencing is performed based on data in multiple modalities, such as inferencing based on visual data and sensor data generated in parallel).

In some aspects, the global machine learning model may be a model trained to generate inferences based on a fusion of data from a first modality and a second modality. The second modality may be different from the first modality. For example, the first modality may be a video modality, and the second modality may be a sensory data modality.

At block 420, the operations 400 proceed with refining one or more of the modality-specific encoders of the global machine learning model based on contrastive learning with modality-specific data at the local device.

In some aspects, refining the one or more of the modality-specific encoders of the global machine learning model includes retraining the one or more of the modality-specific encoders of the global machine learning model based on a contrastive loss metric measured between data representations generated by the one or more of the modality-specific encoders based on data used to train the global machine learning model and data representations generated by the one or more of the modality-specific encoders based on the modality-specific data at the local device.

In some aspects, the contrastive loss metric may be a logarithmic loss based on a ratio between (1) a similarity metric between the data representations generated by the one or more of the modality-specific encoders and data representations generated by the refined one or more modality-specific encoders and (2) a difference metric between the data representations generated by the refined one or more modality-specific encoders for different pairs of inputs. By using this contrastive loss metric, the refined modality-specific encoders may be trained to maximize, or at least increase, agreement between projections of encodings generated by the refined modality-specific encoders and minimize, or at least reduce, agreement between encodings generated by frozen modality-specific encoders (e.g., the modality-specific encoders defined for the global machine learning model and received from the server).

In some aspects, the modality-specific data at the local device may be unlabeled data at the local device.

In some aspects, the operations 400 further include transmitting, to the server, information defining the refined one or more modality-specific encoders of the global machine learning model. The information defining the refined one or more modality-specific encoders of the global machine learning model may include, for example, weights, biases, hyperparameters, and other data defining the refined one or more modality-specific encoders.

In some aspects, the operations 400 further include generating an inference for an input data set based on the global machine learning model and the refined one or more modality-specific encoders. In some aspects, the input data set includes data from a first modality and does not include data from a second modality, and the second modality may be different from the first modality. In some aspects, the input data set includes data from a first modality and data from a second modality, and the second modality may be different from the first modality.

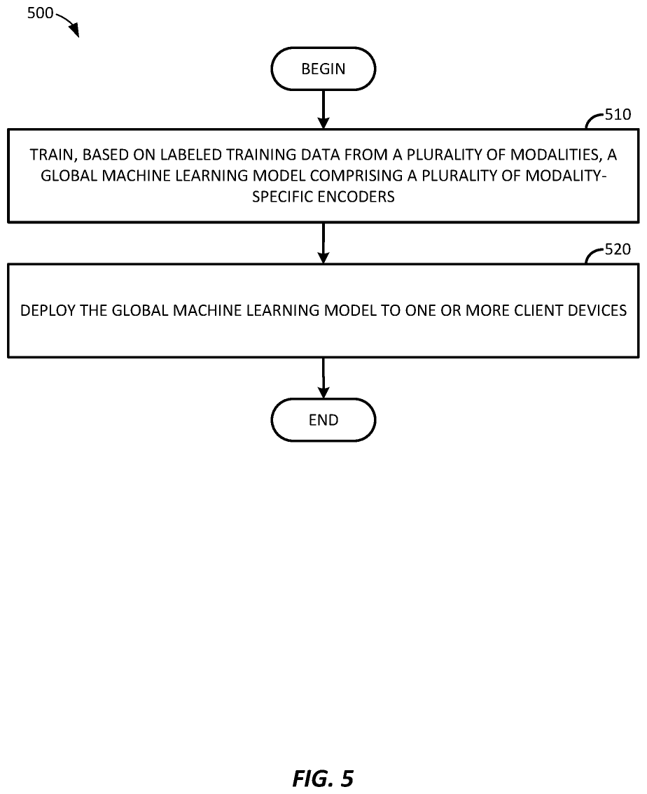

FIG. 5 illustrates example operations 500 that may be performed by a server (e.g., the server 120 illustrated in FIG. 1) to distribute a multimodal machine learning model (e.g., as discussed with respect to the example 200 illustrated in FIG. 2 and/or the example 300 illustrated in FIG. 3) to a plurality of client devices (e.g., the client devices 110), according to aspects of the present disclosure.

As illustrated, the operations 500 begin at block 510 with training, based on labeled training data from a plurality of modalities, a global machine learning model. Generally, the global machine learning model includes a plurality of modality-specific encoders, and each respective encoder of the plurality of modality-specific encoders may be trained to encode data from a respective data modality into a latent space representation.

In some aspects, the global machine learning model may be trained based on a contrastive loss calculated between pairs of samples in a training data set.

In some aspects, the global machine learning model may be a model trained to fuse latent space representations generated by the plurality of modality-specific encoders into a combined representation based on which an inference can be generated. The model may allow for inferencing based on a single modality-specific encoder (e.g., when inferencing is performed based on data in a single modality and without data from a second modality, such as inferencing based on visual data alone, inferencing based on sensor data alone, or the like) or a fusion of encoded outputs generated by a plurality of modality-specific encoders (e.g., when inferencing is performed based on data in multiple modalities, such as inferencing based on visual data and sensor data generated in parallel).

In some aspects, the global machine learning model may be a model trained to generate inferences based on a fusion of data from a first modality and a second modality. The second modality may be different from the first modality. For example, the first modality may be a video modality, and the second modality may be a sensory data modality.

At block 520, the operations 500 proceed with deploying the global machine learning model to one or more client devices (e.g., 110 in FIG. 1).

In some aspects, the operations 500 further include transmitting, to one or more client devices, a request to update one or more modality-specific encoders in the global machine learning model based on modality-specific data at the one or more client devices. Updates to the one or more modality-specific encoders are received from the one or more client devices, and the global machine learning model is updated based on the received updates to the one or more modality-specific encoders.

In some aspects, the one or more client devices comprise a set of client devices having data associated with one of a plurality of modalities.

In some aspects, the updates to the one or more modality-specific encoders comprise updates generated based on the labeled training data used to train the global machine learning model and unlabeled sample data at each of the one or more client devices.

### Example Processing Systems for Training Multimodal Machine Learning Models Using Cross-Modality Contrastive Learning

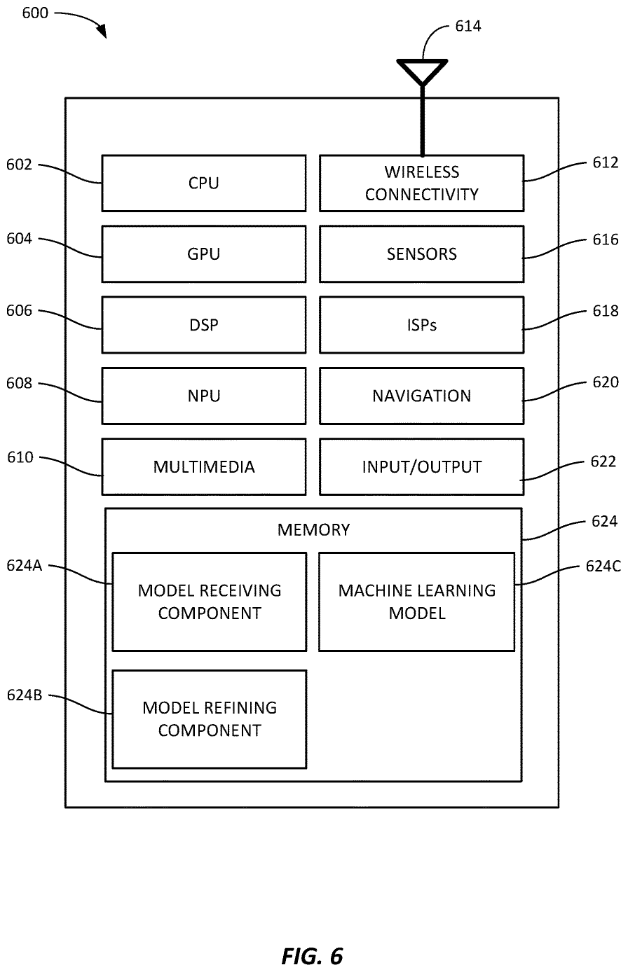

FIG. 6 depicts an example processing system 600 for training a multimodal machine learning model using cross-modality contrastive learning, such as described herein for example with respect to FIGS. 2-4.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., of memory 624).

The processing system 600 also includes additional processing components tailored to specific functions, such as a graphics processing unit (GPU) 604, a digital signal processor (DSP) 606, a neural processing unit (NPU) 608, and a wireless connectivity component 612.

An NPU, such as the NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 608 is a part of one or more of the CPU 602, the GPU 604, and/or the DSP 606. These may be located on a user equipment (UE) in a wireless communication system or another computing device.

In some examples, the wireless connectivity component 612 may include subcomponents, for example, for third generation (3G) connectivity, fourth generation (4G) connectivity (e.g., Long Term Evolution (LTE)), fifth generation (5G) connectivity (e.g., New Radio (NR)), Wi-Fi connectivity, Bluetooth connectivity, and other wireless data transmission standards. The wireless connectivity component 612 may be further coupled to one or more antennas 614.

The processing system 600 may also include one or more sensor processing units 616 associated with any manner of sensor, one or more image signal processors (ISPs) 618 associated with any manner of image sensor, and/or a navigation component 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a model receiving component 624A, a model refining component 624B, and a machine learning model 624C. The depicted components, and others not depicted, may be configured to perform various aspects of the methods described herein.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation component 620 may be omitted in other aspects. Further, elements of the processing system 600 may be distributed, such as training a model and using the model to generate inferences.

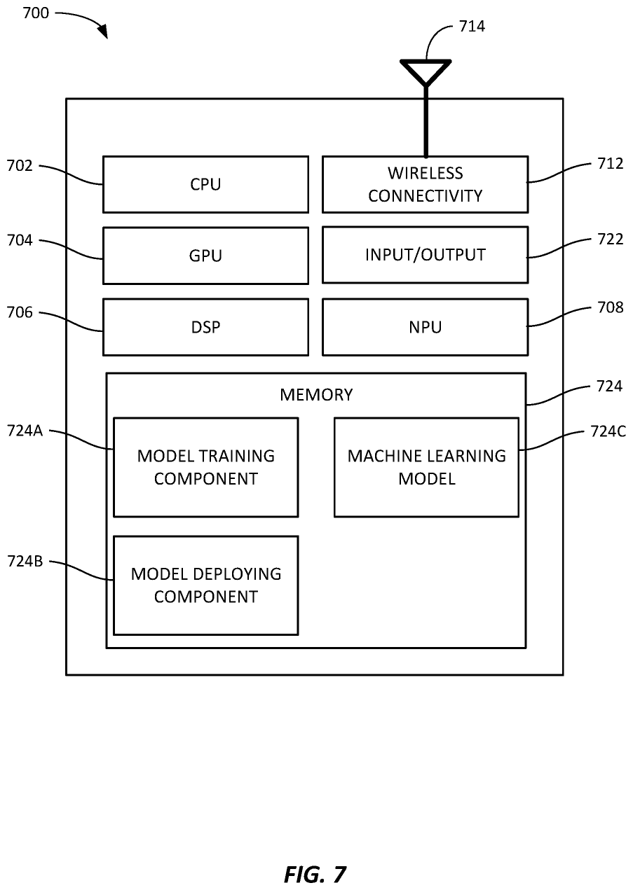

FIG. 7 depicts an example processing system 700 for distributing training of a machine learning model across client devices, such as described herein for example with respect to FIGS. 2, 3, and 5.

The processing system 700 includes a central processing unit (CPU) 702, which in some examples may be a multi-core CPU. Instructions executed at the CPU 702 may be loaded, for example, from a program memory associated with the CPU 702 or may be loaded from a memory 724.

Processing system 700 also includes additional processing components tailored to specific functions, such as a graphics processing unit (GPU) 704, a digital signal processor (DSP) 706, a neural processing unit (NPU) 708, and a wireless connectivity component 712.

An NPU, such as the NPU 708, may be as described above with respect to FIG. 6. In some implementations, the NPU 708 is a part of one or more of the CPU 702, the GPU 704, and/or the DSP 706.

In some examples, wireless connectivity component 712 may be as described above with respect to FIG. 6 and may be coupled with one or more antennas 714.

The processing system 700 may also include one or more sensor processing units 716 associated with any manner of sensor, one or more image signal processors (ISPs) 718 associated with any manner of image sensor, and/or a navigation component 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a model training component 724A, a model deploying component 724B, and a machine learning model 724C. The depicted components, and others not depicted, may be configured to perform various aspects of the methods described herein.

Generally, the processing system 700 and/or components thereof may be configured to perform the methods described herein.

Notably, in other aspects, elements of the processing system 700 may be omitted, such as where the processing system 700 is a server computer or the like. For example, the multimedia component 710, the wireless connectivity component 712, the sensor processing units 716, the ISPs 718, and/or the navigation component 720 may be omitted in other aspects. Further, elements of the processing system 700 may be distributed, such as training a model and using the model to generate inferences.

### Example Clauses

Implementation details of various aspects of the present disclosure are described in the following numbered clauses.
Clause 1: A processor-implemented method, comprising: receiving, at a local device from a server, information defining a global machine learning model, the global machine learning model comprising a plurality of modality-specific encoders, each respective encoder of the plurality of modality-specific encoders being trained to encode data from a respective data modality into a latent space representation; and refining one or more of the modality-specific encoders of the global machine learning model based on contrastive learning with modality-specific data at the local device.
Clause 2: The method of Clause 1, further comprising transmitting, to the server, information defining the refined one or more modality-specific encoders of the global machine learning model.
Clause 3: The method of Clause 1 or 2, wherein the global machine learning model comprises a model trained to fuse latent space representations generated by the plurality of modality-specific encoders into a combined representation based on which an inference can be generated.
Clause 4: The method of any of Clauses 1 through 3, wherein refining the one or more of the modality-specific encoders of the global machine learning model comprises retraining the one or more of the modality-specific encoders of the global machine learning model based on a contrastive loss metric measured between data representations generated by the one or more of the modality-specific encoders based on data used to train the global machine learning model and data representations generated by the one or more of the modality-specific encoders based on the modality-specific data at the local device.
Clause 5: The method of Clause 4, wherein the contrastive loss metric comprises a logarithmic loss based on a ratio between (1) a similarity metric between the data representations generated by the one or more of the modality-specific encoders and data representations generated by the refined one or more modality-specific encoders and (2) a difference metric between the data representations generated by the refined one or more modality-specific encoders for different pairs of inputs.
Clause 6: The method of any of Clauses 1 through 5, wherein the modality-specific data at the local device comprises unlabeled data at the local device.
Clause 7: The method of any of Clauses 1 through 6, wherein the global machine learning model comprises a model trained to generate inferences based on a fusion of data from a first modality and a second modality, the second modality being different from the first modality.
Clause 8: The method of Clause 7, wherein the first modality is a video modality and wherein the second modality is a sensory data modality.
Clause 9: The method of any of Clauses 1 through 8, wherein the global machine learning model comprises a model trained to generate an inference for input data in a first modality without input data from a second modality.
Clause 10: The method of any of Clauses 1 through 9, further comprising generating an inference for an input data set based on the global machine learning model and the refined one or more modality-specific encoders.
Clause 11: The method of Clause 10, wherein the input data set includes data from a first modality and does not include data from a second modality, the second modality being different from the first modality.
Clause 12: The method of Clause 10 or 11, wherein the input data set includes data from a first modality and data from a second modality, the second modality being different from the first modality.
Clause 13: A processor-implemented method, comprising: training, based on labeled training data from a plurality of modalities, a global machine learning model, the global machine learning model comprising a plurality of modality-specific encoders, each respective encoder of the plurality of modality-specific encoders being trained to encode data from a respective data modality into a latent space representation; and deploying the global machine learning model to one or more client devices.
Clause 14: The method of Clause 13, further comprising: transmitting, to one or more client devices, a request to update one or more modality-specific encoders in the global machine learning model based on modality-specific data at the one or more client devices; receiving, from the one or more client devices, updates to the one or more modality-specific encoders; and updating the global machine learning model based on the received updates to the one or more modality-specific encoders.
Clause 15: The method of Clause 13 or 14, wherein the updates to the one or more modality-specific encoders comprise updates generated based on the labeled training data used to train the global machine learning model and unlabeled sample data at each of the one or more client devices.
Clause 16: The method of any of Clauses 13 through 15, wherein the one or more client devices comprise a set of client devices having data associated with one of a plurality of modalities.
Clause 17: The method of any of Clauses 13 through 16, wherein the global machine learning model comprises a model trained to fuse latent space representations generated by the plurality of modality-specific encoders into a combined representation based on which an inference can be generated.
Clause 18: The method of any of Clauses 13 through 17, wherein training the global machine learning model comprises training the global machine learning model based on a contrastive loss calculated between pairs of samples in a training data set.
Clause 19: An apparatus, comprising: a memory having executable instructions stored thereon; and a processor configured to execute the executable instructions to cause the apparatus to perform a method in accordance with any of Clauses 1 through 18.
Clause 20: An apparatus, comprising means for performing a method in accordance with any of Clauses 1 through 18.
Clause 21: A non-transitory computer-readable medium having instructions stored thereon which, when executed by one or more processors, perform a method in accordance with of any of Clauses 1 through 18.
Clause 22: A computer program product embodied on a computer-readable storage medium comprising code for performing a method in accordance with any of Clauses 1 through 18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processing system, comprising:
at least one memory having executable instructions stored thereon; and
one or more processors configured to execute the executable instructions in order to cause the processing system to:
receive, at a local device from a server, information defining a global machine learning model, the global machine learning model comprising a plurality of modality-specific encoders, each respective encoder of the plurality of modality-specific encoders being trained to encode data from a respective data modality into a latent space representation; and
refine one or more of the modality-specific encoders of the global machine learning model based on contrastive learning with modality-specific data at the local device.

2. The processing system of claim 1, wherein the one or more processors are further configured to cause the processing system to transmit, to the server, information defining the refined one or more modality-specific encoders of the global machine learning model.

3. The processing system of claim 1, wherein the global machine learning model comprises a model trained to fuse latent space representations generated by the plurality of modality-specific encoders into a combined representation based on which an inference can be generated.

4. The processing system of claim 1, wherein to refine the one or more of the modality-specific encoders of the global machine learning model, the one or more processors are configured to cause the processing system to retrain the one or more of the modality-specific encoders of the global machine learning model based on a contrastive loss metric measured between data representations generated by the one or more of the modality-specific encoders based on data used to train the global machine learning model and data representations generated by the one or more of the modality-specific encoders based on the modality-specific data at the local device.

5. The processing system of claim 4, wherein the contrastive loss metric comprises a logarithmic loss based on a ratio between (1) a similarity metric between the data representations generated by the one or more of the modality-specific encoders and data representations generated by the refined one or more modality-specific encoders and (2) a difference metric between the data representations generated by the refined one or more modality-specific encoders for different pairs of inputs.

6. The processing system of claim 1, wherein the modality-specific data at the local device comprises unlabeled data at the local device.

7. The processing system of claim 1, wherein the global machine learning model comprises a model trained to generate inferences based on a fusion of data from a first modality and a second modality, the second modality being different from the first modality.

8. The processing system of claim 1, wherein the global machine learning model comprises a model trained to generate an inference for input data in a first modality without input data from a second modality.

9. The processing system of claim 1, wherein the one or more processors are further configured to cause the processing system to generate an inference for an input data set based on the global machine learning model and the refined one or more modality-specific encoders.

10. The processing system of claim 9, wherein the input data set includes data from a first modality and does not include data from a second modality, the second modality being different from the first modality.

11. The processing system of claim 9, wherein the input data set includes data from a first modality and data from a second modality, the second modality being different from the first modality.

12-16. (canceled)

17. A processor-implemented method, comprising:
receiving, at a local device from a server, information defining a global machine learning model, the global machine learning model comprising a plurality of modality-specific encoders, each respective encoder of the plurality of modality-specific encoders being trained to encode data from a respective data modality into a latent space representation; and
refining one or more of the modality-specific encoders of the global machine learning model based on contrastive learning with modality-specific data at the local device.

18. The method of claim 17, further comprising transmitting, to the server, information defining the refined one or more modality-specific encoders of the global machine learning model.

19. The method of claim 17, wherein the global machine learning model comprises a model trained to fuse latent space representations generated by the plurality of modality-specific encoders into a combined representation based on which an inference can be generated.

20. The method of claim 17, wherein refining the one or more of the modality-specific encoders of the global machine learning model comprises retraining the one or more of the modality-specific encoders of the global machine learning model based on a contrastive loss metric measured between data representations generated by the one or more of the modality-specific encoders based on data used to train the global machine learning model and data representations generated by the one or more of the modality-specific encoders based on the modality-specific data at the local device.

21. The method of claim 20, wherein the contrastive loss metric comprises a logarithmic loss based on a ratio between (1) a similarity metric between the data representations generated by the one or more of the modality-specific encoders and data representations generated by the refined one or more modality-specific encoders and (2) a difference metric between the data representations generated by the refined one or more modality-specific encoders for different pairs of inputs.

22. The method of claim 17, wherein the modality-specific data at the local device comprises unlabeled data at the local device.

23. The method of claim 17, wherein the global machine learning model comprises a model trained to generate inferences based on a fusion of data from a first modality and a second modality, the second modality being different from the first modality.

24. The method of claim 17, wherein the global machine learning model comprises a model trained to generate an inference for input data in a first modality without input data from a second modality.

25. The method of claim 17, further comprising generating an inference for an input data set based on the global machine learning model and the refined one or more modality-specific encoders.

26. (canceled)
